(19) United States
(12) Patent Application Publication
(10) Pub. No.: US 2007/0084430 A1
(43) Pub. Date: Apr. 19, 2007

(54) Engine start control apparatus and engine start control method

(75) Inventors: Hiroki Hatayama, Ebina-shi (JP); Takashi Eguchi, Fujisawa-shi (JP); Tetsuya Asada, Hadano-shi (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 11/582,331

(22) Filed: Oct. 18, 2006

(30) Foreign Application Priority Data
Oct. 19, 2005 (JP) 2005-304617

(51) Int. Cl. F02N 17/00

(52) U.S. Cl. 123/179.14

(57) ABSTRACT

When a user presses an engine start switch after an engine is started and then stalled, it is determined whether an engine state signal that is input from an engine control module is a signal indicative of complete explosion of the engine, and when the engine state signal is the signal indicative of the complete explosion of the engine, if a state where the number of revolutions of the engine is equal to or less than a predetermined number of revolutions of the engine is continued for a predetermined time, a starting process of the engine is started.

### BACKGROUND OF THE INVENTION

The present invention relates to an engine start control apparatus that controls start and stop of an engine.

There is a conventionally known system in which a passenger presses an operation button provided in a passenger room in a state where the passenger has a portable device, thereby starting or stopping an engine (Japanese Patent Application Laid-open No. 2003-254210). According to this system, if the engine stops (stalls) after one complete explosion of the engine or before complete explosion of the engine, it is necessary that the user again presses the operation button to start the engine.

### SUMMARY OF THE INVENTION

According to the conventional system, however, it is determined whether the engine is stalled based on the engine state determined by an engine controller. Even when the revolution number of the engine is reduced, there is a possibility that the engine can restore by its own power. Therefore, a predetermined time is required to determine that the engine is completely stalled. That is, there is a problem that unless the predetermined time for determining the engine stall elapses, an engine restarting process cannot be performed, and it takes time to restart the engine after the engine is stalled.

The present invention provides an engine start control apparatus and the engine start control method, wherein it is determined whether an engine is stalled based on the number of revolutions of the engine, and if it is determined that the engine is stalled and if the engine starting operation by a user is detected, an engine starting process is started.

### BRIEF DESCRIPTION OF THE DRAWINGS

FIG. 1 shows a configuration of an engine start control apparatus according to an embodiment of the present invention;

FIG. 2 is a flowchart showing processing contents performed by the engine start control apparatus according to the embodiment; and

FIG, 3 is a time chart showing a state of an engine, the number of revolutions of the engine calculated based on a POSITION signal, a state of an engine state signal, the number of revolutions of the engine calculated based on a REF signal, and a cranking time counted by a cranking timer.

### DETAILED DESCRIPTION OF THE PREFERRED EMBODIMENTS

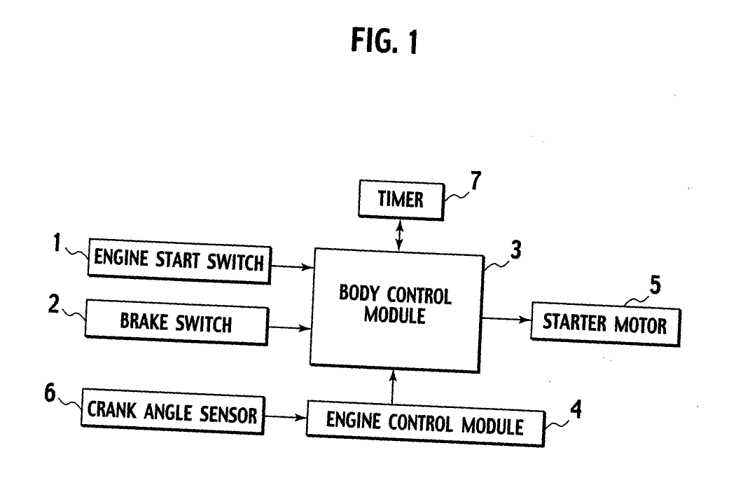

A case where an engine start control apparatus according to an embodiment of the present invention is applied to an AT vehicle will be explained. FIG. 1 shows a configuration of the engine start control apparatus according to the embodiment. The engine start control apparatus includes an engine start switch 1, a brake switch 2, a body control module 3, an engine control module 4, a starter motor 5, a crank angle sensor 6 and a timer 7.

The engine start switch 1 is a button type switch operated by a passenger when an engine (not shown) is to be started, and if the engine start switch 1 is pressed when predetermined conditions are satisfied, start control of the engine is started. The engine start switch 1 is also used when each power supply position is shifted. According to a conventional engine start control method in which an engine is started by turning an ignition key, control of each power supply position is performed based on a position of the turned ignition key. According to the present system in which engine is started by operating the engine start switch 1, shifting control to the power supply positions (LOCK, OFF, ACC, IGN, ST, and RUN) is controlled by the body control module 3 based on the operation of the engine start switch 1.

When the engine start switch 1 is pressed, if predetermined engine starting conditions are satisfied, the starter motor 5 is rotated and driven by the body control module 3 to start the engine. The engine control module 4 performs general engine control, and outputs a signal indicative of a state of the engine to the body control module 3. For example, when the number of revolutions of the engine reaches a predetermined number of revolutions of the engine, the engine control module 4 outputs a signal indicative of complete explosion. The complete explosion means that the engine is started.

Even when the number of revolutions of the engine is lowered after the complete explosion of the engine, if the number of revolutions of the engine is in a range of 200 rpm to 400 rpm, there is a possibility that the engine is restored by its own power. Therefore, even when the number of revolutions of the engine becomes equal to or lower than the number of revolutions of the engine in its start state, the engine control module 4 outputs a signal indicative of the compilete explosion of the engine to the body control module 3 until a predetermined engine stall determining time (e.g., 1.5 seconds) is elapsed, and after the predetermined engine stall determining time is elapsed, if the number of revolutions of the engine is still equal to or lower than the number of revolutions of the engine in its start state, the engine control module 4 outputs an engine state signal indicative of stall of the engine to the body control module 3.

The brake switch 2 is turned ON if a brake pedal is pressed in. The crank angle sensor 6 outputs a REF signal and a POSITION signal based on a crank angle to the engine control module 4. The REF signal is used for calculating the number of revolutions of the engine, and the REF signal is output in three pulses in the case of a six-cylinder engine, and is output in two pulses in the case of a four-cylinder engine. The POSITION signal is used for calculating the number of revolutions of the engine, and the POSITION signal is output in 180 pulses per one revolution of the engine. The calculation of the number of revolutions of the engine based on the REF signal or the POSITION signal is performed by the engine control module 4.

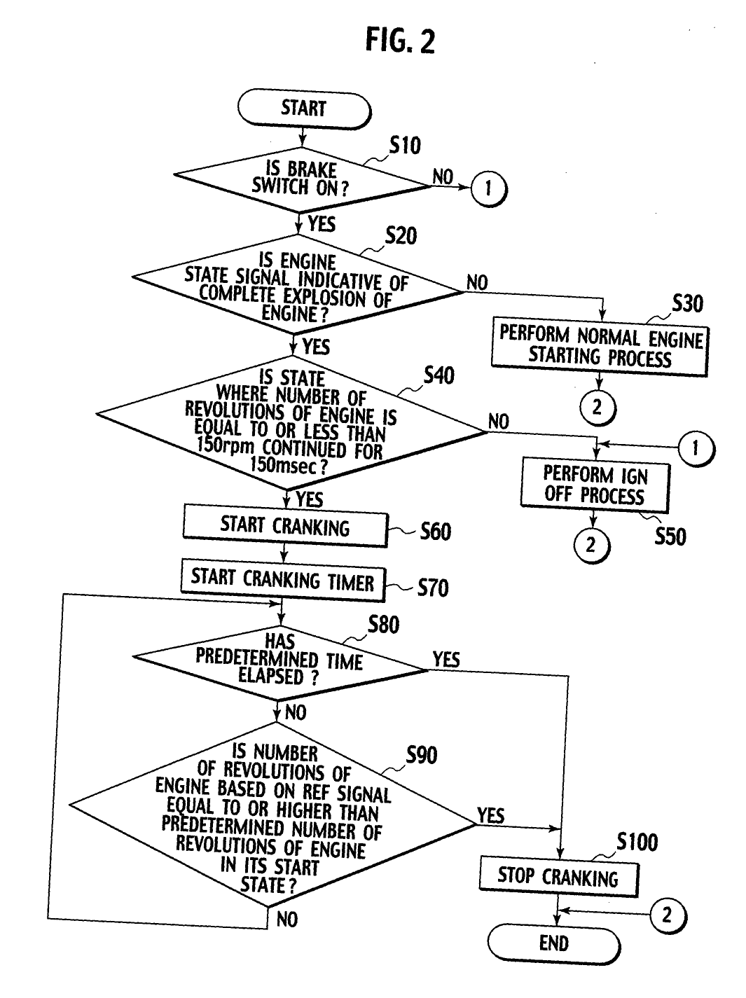

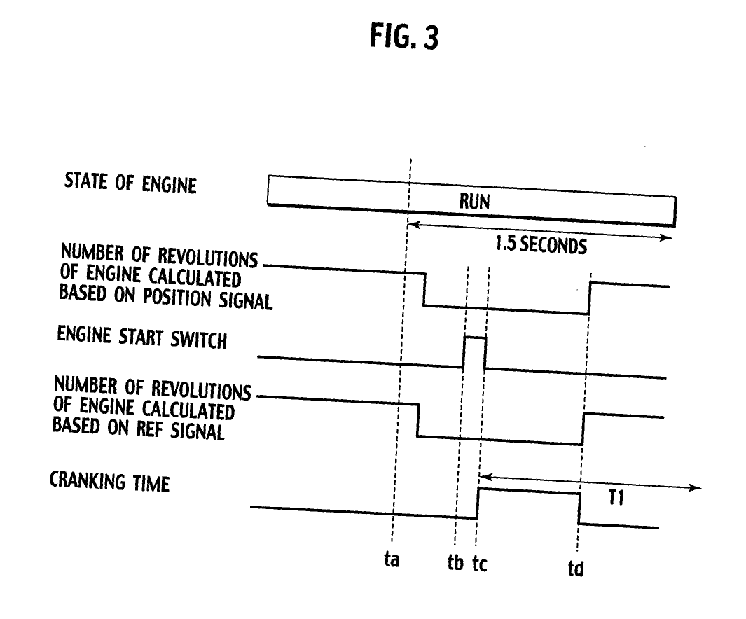

FIG. 2 is a flowchart showing processing contents performed by the engine start control apparatus according to the embodiment. After the engine is stalled, if a user again presses the engine start switch 1 to restart the engine, the body control nodule 3 starts the process at step S10.

At step S10, it is determined whether the brake switch 2 is ON. If it is determined that the brake switch 2 is not ON, the procedure is advanced to step S50, and if it is determined that the brake switch 2 is ON, the procedure is advanced to step S20. At step S20, an engine state signal indicative of the engine state is obtained from the engine control module 4, and it is determined whether the obtained engine state signal indicates the complete explosion of the engine. If the engine state signal is not a signal indicative of the complete explosion of the engine, the procedure is advanced to step S30.

At step S30, a normal engine starting process is performed. The normal engine starting process is an engine starting process that is performed when the user presses the engine start switch 1 to start the engine.

At step S20, if it is determined that the engine state signal indicates the complete explosion of the engine, the procedure is advanced to step S40. At step S40, data concerning number of revolutions of the engine calculated based on the POSITION signal is obtained from the engine control module 4 every predetermined time, and based on the obtained data concerning the number of revolutions of the engine, it is determined whether the state where the number of revolutions of the engine is equal to or lower than 150 rpm is continued for 150 msec. If it is not determined that the state where the number of revolutions of the engine is equal to or lower than 150 rpm is continued for 150 msec, the procedure is advanced to step S50. At step S50, a process for turning the ignition OFF, i.e., a process for shifting the power supply position to OFF is performed.

At step S40, if it is determined that the state where the number of revolutions of the engine is equal to or lower than 150 rpm is continued for 150 msec, the procedure is advanced to step S60. At step S60, the starter motor 5 is rotated and driven, the cranking of the engine is started. If the cranking is started, the procedure is advanced to step S70.

At step S70, time counting by the timer 7 is started to counting the cranking time, and the procedure is advanced to step S80. At step S80, it is determined whether the time counted by the timer 7 elapses a predetermined time T1. If it is determined that the time counted by the timer 7, i.e., the cranking time elapses the predetermined time T1, the procedure is advanced to step S100. At step S100, even if the cranking time elapses the predetermined time T1, the engine is not started. Therefore, the rotation and driving of the starter motor 5 are stopped, thereby stopping the cranking.

At step S80, if it is determined that the time counted by the timer 7 does not elapse the predetermined time T1, the procedure is advanced to step S90. At step S90, data concerning the number of revolutions of the engine calculated based on the REF signal is obtained from the engine control module 4, and it is determined whether the number of revolutions of the engine is equal to or higher than the number of revolutions of the engine in its start state based on the obtained data concerning the number of revolutions of the engine. If it is determined that the number of revolutions of the engine is less than the number of revolutions of the engine in its start state, the procedure is advanced to step S100. At step S100, since the engine is started, the rotation and driving of the starter motor 5 are stopped to stop the cranking.

FIG. 3 is a time chart showing the state of the engine, the number of revolutions of the engine calculated based on the POSITION signal, the state of the engine state signal, the number of revolutions of the engine calculated based on the REF signal, and a cranking time counted by a cranking timer. Even if the engine is stalled at a time ta, the engine control module 4 outputs a signal indicative of complete explosion of the engine (RUN) to the body control module 3 for a predetermined engine stall determining time (e.g., 1.5 seconds) from the time ta.

At a time tb, if the user presses the engine start switch 1, the body control module 3 indicates that the brake switch 2 is ON and the engine state signal is the complete explosion of the engine, and at a time tc when it is determined that a state where the number of revolutions of the engine calculated based on the POSITION signal is 150 rpm or less continued for 150 msec, the body control module 3 starts the cranking of the engine.

After the cranking of the engine is started, at a time td, if it is detected that the number of revolutions of the engine calculated based on the REF signal becomes equal to or higher than the predetermined number of revolutions of the engine in its start state, the cranking of the engine is stopped. According to the conventional system that determines the stall of the engine based on the engine state, it is not determined that the engine is stalled unless a predetermined engine stall determining time (e.g., 1.5 seconds) is elapsed after the time ta at which the engine is stalled. Therefore, if the engine stall determining time is not elapsed, the restart process of the engine cannot be performed. According to the engine start control apparatus, however, it is determined that the engine is stalled if the state where the number of revolutions of the engine is equal to or less than the predetermined number of revolutions of the engine (150 rpm) is continued for the predetermined time (150 msce), the time required for restarting the engine after the engine stalled can be shortened.

Even when the number of revolutions of the engine does not become equal to or higher than the number of revolutions of the engine in its start state at the time of cranking, the cranking of the engine is stopped if the cranking time elapses the predetermined time T1 as described above.

According to the engine start control apparatus of the embodiment, it is determined that the engine is stalled based on the number of revolutions of the engine, and if the engine starting operation by a user is detected, the engine starting process is started. Thus, the time required for restarting the engine after the engine is stalled can be shortened. In the above described conventional system that determines the stall of the engine based on the engine state, it is not determined that the engine is stalled unless the predetermined engine stall determining time (e.g., 1.5 seconds) is not elapsed after the engine is stalled. Therefore, the engine restarting process cannot be performed unless the engine stall determining time is not elapsed. According to the engine start control apparatus of the embodiment, however, even if the predetermined engine stall determining time is not elapsed after the engine is stalled and the engine state determined by the engine control module shows the complete explosion of the engine, it is possible to determine whether the engine is stalled based on the number of revolutions of the engine, and to swiftly perform the restarting process of the engine.

According to the engine start control apparatus of the embodiment, if the state where the number of revolutions of the engine is equal to or less than the predetermined number of revolutions of the engine (150 rpm in the present embodiment) is continued from a predetermined time (150 msec in the present embodiment), it is determined that the engine is stalled. Therefore, it is possible to swiftly and reliably determine the stall state of the engine.

According to the engine start control apparatus of the embodiment, if the number of revolutions of the engine becomes equal to or higher than the number of revolutions of the engine in its start state, it is determined that the engine is started. Therefore, it is possible to swiftly and reliably determine that the engine is started.

The present invention is not limited to this embodiment. For example, in the system of the embodiment, the engine is started by the pressing operation of the engine start switch 1. However, the invention can be also applied to a system in which a user having a portable key turns an engine starting knob to start the engine.

Although the engine start control apparatus is applied to the automatic car in the present embodiment, the invention can be also applied to a stick-shift car. At step S10 in the flowchart in FIG. 2, when the invention is applied to a stick-shift car, instead of determining whether the brake switch 2 is ON, it is determined whether the clutch pedal is pressed in, and if it is determined so, the procedure is advanced to step S20.

In the present embodiment, it is determined that the engine is stalled when the state where the number of revolutions of the engine is equal to or less than 150 rpm is continued for 150 msec, but the predetermined number of revolutions of the engine is not limited to 150 rpm, and the determining time is not limited to 150 msec. It is necessary that the determining time is shorter than the engine stall determining time (e.g., 1.5 seconds). It is preferable that the predetermined number of revolutions of the engine at which it is determined that the engine is stalled is lower than 200 revolutions to 400 revolutions at which there is a possibility that the engine can restore by its own power.

A corresponding relationship between constituent elements of the appended claims and constituent elements of the embodiment is as follows. That is, the crank angle sensor 6 and the engine control module 4 constitute an engine revolution number detector, the body control module 3 constitutes an engine stall determining unit, a controller and an engine stall determining unit, and the engine start switch 1 and the body control module 3 constitute an engine starting operation detector. Note that the above explanation is only an example of the present invention, and the invention is by no means limited to the corresponding relationship between the constituent elements of the appended claims and the constituent elements of the embodiment.

According to the engine start control apparatus and the engine start control method of the present invention, it is determined whether the engine is stalled based on the number of revolutions of the engine, and if the engine starting operation by a user is detected, the starting process of the engine is started. Therefore, the time required for restarting the engine after the engine is stalled can be shortened.

Description has been made of the embodiments to which the invention created by the inventors of the present invention is applied. However, the present invention is not limited to the descriptions and the drawings, which form a part of the disclosure of the present invention according to these embodiments. Specifically, all of other embodiments, examples, operational techniques and the like, which are made by those skilled in the art based on these embodiments, are naturally incorporated in the scope of the present invention. The above is additionally described at the end of this specification.

The entire content of Japanese Patent Application No. TOKUGAN 2005-304617 with a filing date of Oct. 19, 2005 is hereby incorporated by reference.

What is claimed is:

1. An engine start control apparatus comprising
an engine revolution number detector that detects the number of revolutions of an engine,
an engine stall determining unit that determines whether the engine is stalled based on the number of revolutions of the engine detected by the engine revolution number detector,
an engine starting operation detector that detects an engine starting operation by a user, and
a controller that starts an engine starting process if the engine stall determining unit determines that the engine is stalled and the engine starting operation detector detects the engine starting operation.

2. The engine start control apparatus according to claim 1, further comprising an engine start button, wherein
the engine starting operation detector detects a pressing operation of the engine start button by a user as the engine starting operation.

3. The engine start control apparatus according to claim 1, further comprising an engine start determining unit that determines that the engine is started if the number of revolutions of the engine detected by the engine revolution number detector becomes equal to or higher than a predetermined number of revolutions of the engine in its start state after the engine starting process is started by the controller.

4. The engine start control apparatus according to claim 3, wherein
the controller stops cranking if the engine start determining unit determines that the engine is started.

5. The engine start control apparatus according to claim 1, wherein
the engine stall determining unit determines that the engine is stalled when a state where the number of revolutions of the engine detected by the engine revolution number detector is equal to or less than a predetermined number of revolutions of the engine is continued for a predetermined time.

6. The engine start control apparatus according to claim 1, wherein
the engine stall determining unit determines that the engine is stalled when the number of revolutions of the engine detected by the engine revolution number detector is less than a predetermined number which is not zero.

7. An engine start control method, wherein it is determined whether an engine is stalled based on the number of revolutions of the engine, and if a pressing operation of a user of an engine start button is detected, a starting process of the engine is started.
